(19) United States
(12) Patent Application Publication
(10) Pub. No.: US 2019/0327762 A1
(43) Pub. Date: Oct. 24, 2019

(54) USER TERMINAL AND RADIO COMMUNICATION METHOD

(71) Applicant: NTT DOCOMO, INC., Tokyo (JP)

(72) Inventors: Kazuaki Takeda, Tokyo (JP); Kazuki Takeda, Tokyo (JP); Keisuke Saito, Tokyo (JP); Satoshi Nagata, Tokyo (JP)

(73) Assignee: NTT DOCOMO, INC., Tokyo (JP)

(21) Appl. No.: 16/473,954

(22) PCT Filed: Dec. 26, 2017
(86) PCT No.: PCT/JP2017/046559

§ 371 Date: Jun. 26, 2019

(30) Foreign Application Priority Data
Dec. 27, 2016 (JP) 2016-254324

(51) Int. Cl. H04W 74/00; H04W 74/08; H04W 72/04; H04L 5/00

(52) U.S. Cl. CPC H04W 74/002; H04L 5/0048; H04W 72/0406; H04W 74/0833

(57) ABSTRACT

The present invention is designed to provide reference signal configurations that are suitable for user terminals. A user terminal has a transmission section that transmits a random access preamble (PRACH), a control section that controls the transmission of the PRACH by applying a specific PRACH configuration, and a receiving section that receives a DL reference signal, and the control section selects the specific PRACH configuration from a plurality of PRACH configurations, which are associated respectively with a plurality of reference signal configurations that are applied to the transmission of the DL reference signal.

### TECHNICAL FIELD

The present invention relates to a user terminal and a radio communication method in next-generation mobile communication systems.

### BACKGROUND ART

In the UMTS (Universal Mobile Telecommunications System) network, the specifications of long term evolution (LTE) have been drafted for the purpose of further increasing high speed data rates, providing lower latency and so on (see non-patent literature 1). Also, the specifications of LTE-A (also referred to as “LTE-advanced,” “LTE Rel. 10,” “LTE Rel. 11,” or “LTE Rel. 12”) have been drafted for further broadbandization and increased speed beyond LTE (also referred to as “LTE Rel. 8” or “LTE Rel. 9”), and successor systems of LTE (also referred to as, for example, “FRA (Future Radio Access),” “SG (5th generation mobile communication system).” “5G+(plus),” “NR (New Radio),” “NX (New radio access),” “New RAT (Radio Access Technology).” “FX (Future generation radio access),” “LTE Rel. 13,” “LTE Rel. 14,” “LTE Rel. 15” or later versions) are under study.

In LTE Rel. 10/11, carrier aggregation (CA) to integrate multiple component carriers (CC) is introduced in order to achieve broadbandization. Each CC is configured with the system bandwidth of LTE Rel. 8 as one unit. Furthermore, in CA, a plurality of CCs under the same radio base station (referred to as an “eNB (eNodeB),” a “BS” (Base Station) and so on) are configured in a user terminal (UE: User Equipment).

Meanwhile, in LTE Rel. 12, dual connectivity (DC), in which multiple cell groups (CG) formed by different radio base stations are configured in a user terminal, is also introduced. Each cell group is comprised of at least one cell (CC). Since multiple CCs of different radio base stations are aggregated in DC. DC is also referred to as “inter-base station CA (inter-eNB CA).”

In addition, in existing LTE systems (for example, LTE Rel. 8 to 13), when UL synchronization is established between a radio base station and a user terminal, UL data can be transmitted from the user terminal. For this reason, in existing LTE systems, random access procedures (also referred to as “RACH procedures (Random Access CHannel Procedures),” “access procedures,” and so on) for establishing UL synchronization are supported.

In random access procedures, a user terminal acquires information related to UL transmission timing (timing advance (TA) from a response (random access response) which a radio base station sends out in response to a randomly selected preamble (random access preamble), and the user terminal establishes UL synchronization based on this TA.

After UL synchronization is established, the user terminal receives DL control information (DCI) (UL grant) from the radio base station, and then transmits UL data using the UL resource allocated by the UL grant.

### CITATION LIST

### Non-Patent Literature

Non-Patent Literature 1: 3GPP TS36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

Future radio communication systems (for example, 5G, NR, etc.) are expected to realize various radio communication services so as to fulfill varying requirements (for example, ultra-high speed, large capacity, ultra-low latency, etc.).

For example, in relationship to 5G/NR, use cases (for example, communication services) are under study, referred to as “eMBB (enhanced Mobile Broad Band),” “mMTC (massive Machine Type Communication),” “URLLC (Ultra Reliable and Low Latency Communications)” and so on. These use cases are likely to require different conditions for communication. Also, for 5G/NR, studies are under way to use user terminals in environments with different frequencies, different cell structures, different moving speeds of user terminals, and so on. Therefore, it is desirable to support the flexible application of numerologies and frequencies to signal transmission/reception.

Also, in 5G/NR, a reference signal format to show the format of resources allocated to reference signals and/or the like is under research. Given the impact the format of reference signals has on the performance of radio communication systems, it may be necessary to configure appropriate reference signal formats on a per user terminal basis. However, the problem in this case lies in how to determine the reference signal format.

The present invention has been made in view of the above, and it is therefore an object of the present invention to provide a user terminal and a radio communication method, whereby a reference signal format that is suitable for user terminals can be configured.

### Solution to Problem

According to one aspect of the present invention, a user terminal has a transmission section that transmits a random access preamble (PRACH), a control section that controls the transmission of the PRACH by applying a specific PRACH configuration, and a receiving section that receives a DL reference signal, and the control section selects the specific PRACH configuration from a plurality of PRACH configurations, which are associated respectively with a plurality of reference signal configurations that are applied to the transmission of the DL reference signal.

### Advantageous Effects of Invention

According to the present invention, a reference signal format that is suitable for user terminals can be configured.

### BRIEF DESCRIPTION OF DRAWINGS

FIGS. 1A and 1B are diagrams to show a single-BF operation and a multiple-BF operation;

FIGS. 2A and 2B are diagrams to show examples of two RS patterns;

FIG. 3 is a diagram to show an example of contention-based random access procedures;

FIG. 4 is a diagram to show associations between PRACH configurations for transmitting message 1 and RS patterns for transmitting message 2;

FIG. 5 is a diagram to show a random access operation by a user terminal;

FIG. 6 is a diagram to show an example of a schematic structure of a radio communication system according to one embodiment of the present invention;

FIG. 7 is a diagram to show an example of an overall structure of a radio base station according to one embodiment of the present invention;

FIG. 8 is a diagram to show an example of a functional structure of a radio base station according to one embodiment of the present invention;

FIG. 9 is a diagram to show an example of an overall structure of a user terminal according to one embodiment of the present invention;

FIG. 10 is a diagram to show an example of a functional structure of a user terminal according to one embodiment of the present invention; and

FIG. 11 is a diagram to show an example hardware structure of a radio base station and a user terminal according to one embodiment of the present invention.

### DESCRIPTION OF EMBODIMENTS

In 5G, study is in progress to provide services using a very high carrier frequency of, for example, maximum 100 GHz. Generally, it becomes more difficult to secure coverage as the carrier frequency increases. The reasons for this include that the distance-induced attenuation becomes more severe and the rectilinearity of radio waves becomes stronger, the transmission power density decreases because ultra-wideband transmission is performed, and so on.

Therefore, in order to meet the demands of the above-noted various types of communication even in high frequency bands, study is in progress to use massive MIMO (massive MIMO (Multiple Input Multiple Output)), which uses a very large number of antenna elements. When a very large number of antenna elements are used, beams (antenna directivity) can be formed by controlling the amplitude and/or the phase of the signals transmitted/received from each element. This process is also referred to as beam “forming (BF),” and it becomes possible to reduce the propagation loss of radio waves.

BF can be classified into digital BF and analog BF. Digital BF refers to a method of performing precoding signal processing on the baseband (for digital signals). In this case, inverse fast Fourier transform (IFFT)/digital-to-analog conversion (DAC)/RF (Radio Frequency) need to be carried out in parallel processes, as many as the number of antenna ports (RF Chains). Meanwhile, it is possible to form a number of beams according to the number of RF chains at an arbitrary timing.

Analog BF refers to a method of using phase shifting devices on RF. In this case, since it is only necessary to rotate the phase of RF signals, analog BF can be realized with simple and inexpensive configurations, but it is nevertheless not possible to form a plurality of beams at the same time. To be more specific, when analog BF is used, each phase shifting device can only form one beam at a time.

Therefore, if a base station (for example, referred to as an “eNB (evolved Node B),” a “BS (Base Station),” and so on) has only one phase shifting device, only one beam can be formed at a given time. Therefore, when multiple beams are transmitted using analog BF alone, these beams cannot be transmitted simultaneously using the same resources, and the beams need to be switched, rotated and so on, over time.

Note that it is also possible to adopt a hybrid BF configuration which combines digital BF and analog BF. Although study is in progress to introduce massive MIMO in future radio communication systems (for example, 5G), if it is attempted to form an enormous number of beams with digital BF alone, the circuit configuration becomes expensive. For this reason, 5G is assumed to adopt a hybrid BF configuration.

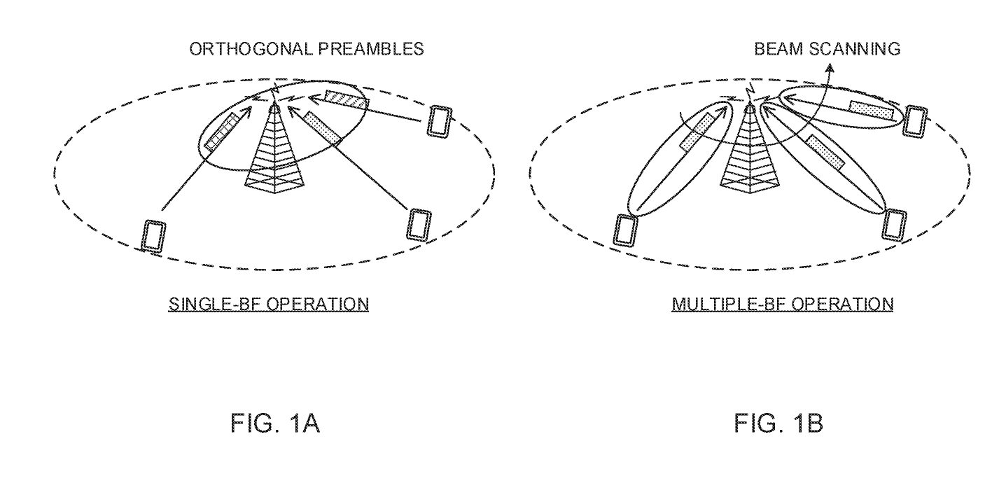

As for the operations of BF, there are a single-BF operation to use one BF, and a multiple-BF operation to use multiple BFs (see FIG. 1). The single-BF operation is similar to existing LTE operations, where a carrier frequency below a given frequency (for example, 6 GHz) is used. The multiple-BF operation includes digital BF, analog BF and hybrid BF.

In UL transmission using the single-BF operation, orthogonal preambles are applied so that UL beams (directivities) are orthogonal among a plurality of user terminals (to prevent contention) (see FIG. 1A). This makes it possible to use the same resources in the frequency domain and the time domain.

The multiple-BF operation has been under research to target carrier frequencies equal to or higher than a given frequency, by using massive antennas. In UL transmission using the multiple-BF operation, BF is applied so that UL beams (directivities) are orthogonal among a plurality of user terminals (to prevent contention). For example, in the multiple-BF operation, transmission may be made a number of times by applying different beam patterns in the time direction, so that an optimal Rx beam may be selected (beam scanning) (see FIG. 1B). In this case, a radio base station receives a signal from a user terminal in a plurality of unit time periods, via different Rx beams.

In the multiple-BF operation, it is possible to reduce the number of orthogonal preambles compared to the single-BF operation. Also, in the multiple-BF operation, different beam patterns are applied in the time direction, so that more PRACH (Physical Random Access Channel) resources are required in the time domain.

Now, various reference signals (RSs) are under study in 5G/NR.

DL reference signals for use include at least one of the demodulation reference signal, which is used to demodulate DL control channels and/or DL data channels (also referred to as “DM-RS (DeModulation-Reference Signal),” “user terminal-specific reference signal (UE-specific reference signal).” etc.), the channel state information reference signal (“CSI-RS”), which is used to measure channel state information (“CSI”), the mobility reference signal (“MRS”), which is used in measurements for beam selection, and the phase noise compensation reference signal (“PTRS (Phase Tracking Reference Signal)”), which is used in phase noise compensation.

Now, the MRS will be explained. In 5G/NR, a study is in progress to provide support for both mobility that requires RRC signaling (for example, handover across cells) and L1/L2 mobility that does not require RRC signaling, in RRC-connected mode (RRC_CONNECTED mode). Also, in 5G/NR, to provide a method for controlling L1/L2 beams in the scenario in which a cell is formed with multiple beams, a study is under way to make measurements and reporting for selecting beams, by using the CSI-RS (CSI measurement RS) or the mobility reference signal (MRS). Here, the MRS has only to be a signal that can be used as an RRM measurement RS, and may be an existing synchronization signal (for example, the PSS/SSS), an existing reference signal (for example, the CRS, the CSI-RS, etc.) or a signal that is enhanced/modified based on these signals. Also, in 5G/NR, there is an idea of measuring and reporting at least one of cell quality and beam quality by using MRSs, NR synchronization signals or other reference signals, to provide RRM measurements (L3 mobility) in RRC-connected mode.

Now, PTRS will be explained below. Phase noise is problematic, especially at high frequencies, and phase noise that remains even when the subcarrier spacing is widened is compensated using PTRS.

Also, as a UL reference signal, at least one of the demodulation reference signal (DM-RS), which is used to demodulate UL control channels and/or UL data channels, and the sounding reference signal (SRS), is used.

A study is on-going to switch RS patterns (reference signal configurations), which show the configurations of each RS like these. Although cases will be described below where the RS is the DM-RS, the RS is not limited to the DM-RS, and can be any one of the above-mentioned RSs, for example.

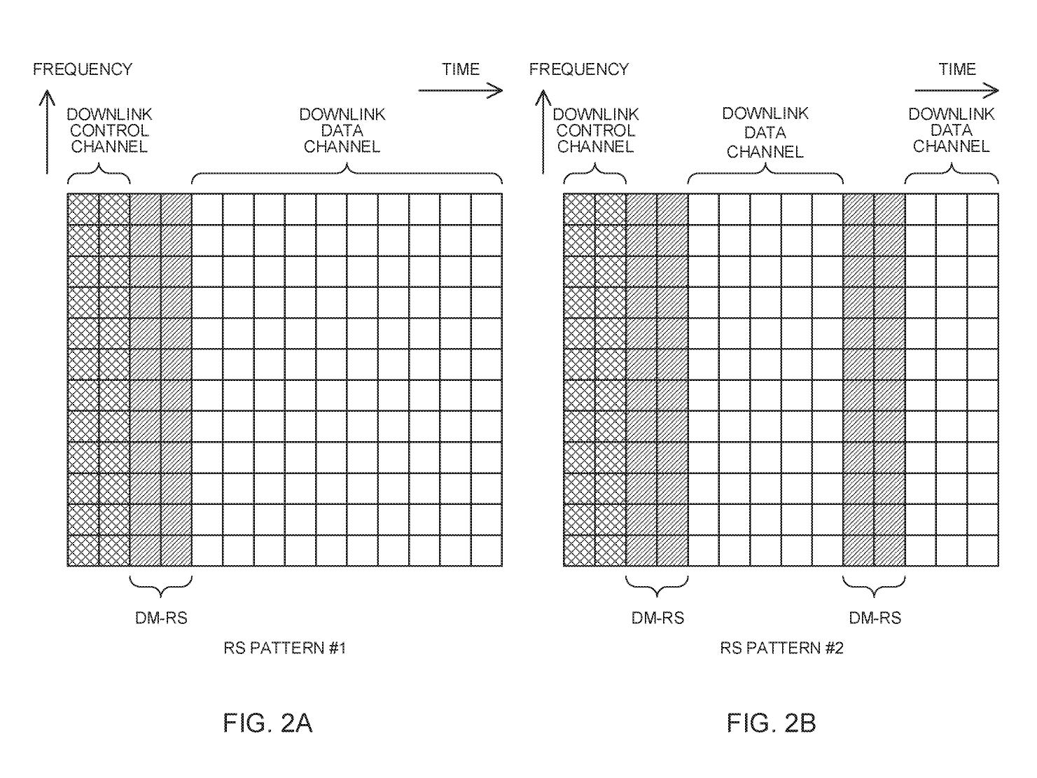

FIG. 2 is a diagram to show examples of two RS patterns. This drawing illustrates frequency resources and time resources that are allocated to a DL control channel (for example, PDCCH (Physical Downlink Control CHannel)), a DM-RS for demodulating a DL data channel (for example, PDSCH (Physical Downlink Shared CHannel)), and a DL data channel, in one PRB ((Physical Resource Block) (12 subcarriers)) and one subframe (14 symbols). Instead of a subframe, a slot, a minislot, a subslot, a radio frame and so on may be used. The RS pattern may show the time resources and frequency resources used for the DM-RS, the transmission signal sequence used for the DM-RS, the amount of phase rotation, and so on.

In this drawing, resources over the entire band of the PRB are allocated to the DL control channel in first two symbols of the subframe. Note that the RS for demodulating the DL control channel may be included in the two symbols. A user terminal controls the receipt of the DL data channel based on DCI transmitted in the DL control channel. Note that the RS pattern may further indicate the DM-RS for demodulating the common search space of the DL control channel.

An RS patterns may be assumed for each one of a plurality of scenarios that show the situation of the user terminal. In FIG. 2, a normal scenario and a high-speed scenario are assumed.

FIG. 2A shows RS pattern #1 for the normal scenario. The normal scenario corresponds to, for example, the case where the moving speed of a user terminal is lower than a given value. In RS pattern #1 for the normal scenario, resources immediately after the DL control channel (for example, two symbols over the entire band of the PRB) are allocated to the DM-RS, and the following resources are allocated to the DL data channel.

When using RS pattern #1, the user terminal performs channel estimation using the DM-RS before the DL data channel, and demodulates the DL data channel based on the result of this.

FIG. 2 B shows RS pattern #2 for the high-speed scenario. The high-speed scenario corresponds to, for example, the case where the moving speed of the user terminal is higher than a given value. In RS pattern #2 for the high-speed scenario, resources immediately after the DL control channel (for example, two symbols over the entire band of the PRB) and resources in the middle of the DL data channel (for example, two symbols over the entire band of the PRB) are allocated to the RS.

When RS pattern #2 is used, the user terminal, after performing channel estimation using the first DM-RS and channel estimation using the second DM-RS, may demodulate the DL data channel based on the results of these. Also, the user terminal may perform channel estimation using the first DM-RS and demodulate the DL data channel based using the result of this, and, following this, the user terminal may correct the result of the first channel estimation by performing channel estimation using the second DM-RS, and demodulate the following DL data channel based on the corrected result.

In addition, the normal scenario may be used when the received quality (for example, the received SINR (Signal to Interference plus Noise Ratio), the RSRP (Reference Signal Received Power), etc.) is higher than given quality, and the high-speed scenario may be used when the received quality is lower than the given quality.

In RS pattern #1, there are more resources to allocate to the DL data channel than in RS pattern #2, so that it is possible to achieve high data rates. In RS pattern #2, there are more resources to allocate to the DM-RS than in RS pattern #1, so that it is possible to improve accuracy of channel estimation, and improve reliability of the demodulation of the DL data channel.

Note that symbols after the DL data channel in a subframe (for example, the last symbol) may be allocated to a UL control channel. A subframe like this is referred to as a “DL-centric subframe,” a “self-contained subframe” and so on. In this case, the user terminal may feed back retransmission control information (HARQ-ACK (Hybrid Automatic Repeat reQuest-Acknowledgment), an ACK (ACKnowledgment) or a NACK (Negative ACK), and so on) in response to the DL data channel by using the UL control channel that is provided in the same time period (also referred to as a “transmission time interval (TTI).” “subframe,” and so on). By this means, it is possible to reduce the latency due to retransmissions.

Similarly, an RS pattern for a subframe containing a UL data channel may be defined. This RS pattern may indicate the configuration of the DM-RS for demodulating the UL data channel. Furthermore, this subframe may be a UL-centric subframe to include a DL control channel, a UL data channel and a UL control channel, or may be a subframe including a UL control channel and a UL data channel.

FIG. 2 shows RS patterns for one transmission layer. It is also possible to provide multiple transmission layers based on MIMO, and configure a DM-RS for each transmission layer's antenna port. In that case, DM-RSs for multiple transmission layers may be orthogonalized and multiplexed by using, for example, CDM (Code Division Multiplexing) and/or FDM (Frequency Division Multiplexing).

Note that the candidates for RS patterns are not limited to the RS patterns of FIGS. 2A and 2B. Also, the number of RS pattern candidates may be three or more. In an RS pattern, the position and order of each channel and RS may be changed.

In this way, by configuring appropriate RS patterns based on the environment of the user terminal and/or other factors, it is possible to perform communication by applying appropriate reference signals to each user terminal.

For example, it is possible to report cell-specific RS patterns to a user terminal via system information. When the environment is determined by the cell, the user terminal can use the RS pattern that is suitable to the environment. Nevertheless, cases might occur where an RS pattern that is not suitable for the user terminal's situation (the use case, the environment, etc.) is configured. For example, the RS pattern that is suitable for cell edges may be different from the RS pattern suitable for the cell center. Likewise, if a user terminal showing a high received SINR uses RS pattern #2, the data rate will decrease lower than when using RS pattern #1.

Furthermore, it may be possible to report user terminal-specific RS patterns to the user terminal by higher layer signaling or physical layer signaling. However, given that RS patterns can be reported only after a higher layer connection is established, it is not possible to configure appropriate RS patterns during random access. Therefore, the performance of communication during random access is lower than the performance after a connection is established.

Therefore, the present inventors propose an idea for allowing a user terminal to select RS patterns during random access.

Now, embodiments of the present invention will be described in detail below with reference to the accompanying drawings. Note that the radio communication methods of the above-described embodiments may be applied individually or may be applied in combination.

(Radio Communication Method)

The present embodiment defines a plurality of RS patterns as candidate RS patterns, defines multiple PRACH configurations as candidate PRACH configurations, and links (associates) multiple RS patterns with multiple PRACH configurations, respectively. These multiple RS patterns and multiple PRACH configurations are configured in radio base stations and user terminals prior to random access. Although a mode will be described below in which a user terminal selects RS patterns upon initial access, the user terminal may select RS patterns at other times of random access.

Now, to illustrate an example of random access procedures for use in initial access, the random access procedures in existing LTE systems (for example, LTE Rel. 8 to 13) will be explained.

Random access procedures include contention-based random access (also referred to as “CBRA” and so on) and non-contention-based random access (also referred to as “non-CBRA,” “contention-free random access (CFRA),” and so on).

In contention-based random access (CBRA), a user terminal transmits a preamble, which is selected randomly from a plurality of preambles provided for each cell (also referred to as “random access preambles,” “random access channels (PRACHs),” “RACH preambles” and so on). Furthermore, contention-based random access is user terminal-initiated random access procedures, and can be used, for example, when gaining initial access, when starting or resuming UL transmission, and so on.

On the other hand, in non-contention-based random access (non-CBRA, CFRA (Contention-Free Random Access), etc.), a radio base station assigns preambles on a per user terminal basis, by using a downlink (DL) control channel (a PDCCH (Physical Downlink Control Channel), an EPDCCH (Enhanced PDCCH), etc.), and a user terminal transmits the preamble assigned by the radio base station. Non-contention-based random access is network-initiated random access procedures, and can be used, for example, when conducting handover, when starting or resuming DL transmission, and so on (when transmission of DL retransmission command information is started or restarted in UL).

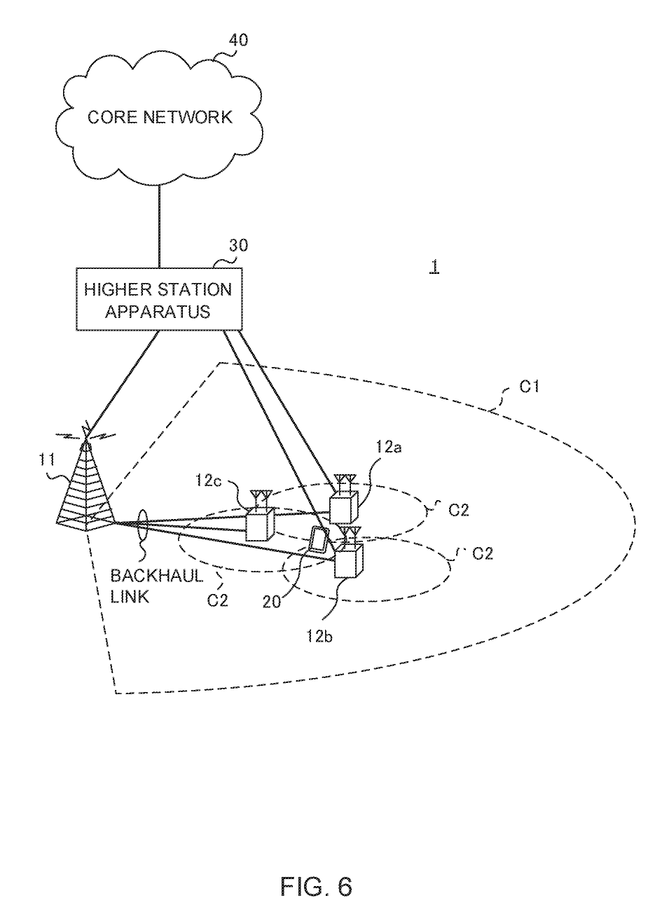

FIG. 6 is a diagram to show an example of random access procedures.

A user terminal receives, in advance, information (PRACH configuration information) that indicates the configurations of random access channels (PRACHs) (PRACH configurations, RACH configurations, etc.) via system information (including broadcast information such as, for example, the master information block (MIB), system information blocks (SIBs)) and/or higher layer signaling (for example, RRC (Radio Resource Control) signaling, MAC (Medium Access Control) signaling, etc.).

The PRACH configuration information can indicate, for example, a plurality of preambles (for example, preamble formats) that are defined in each cell, the time resources that are used in PRACH transmission (including, for example, a system frame index, a subframe index and so on) and the offset (prach-FrequencyOffset) to indicate the starting position of frequency resources (for example, six resource blocks (PRBs (Physical Resource Blocks))).

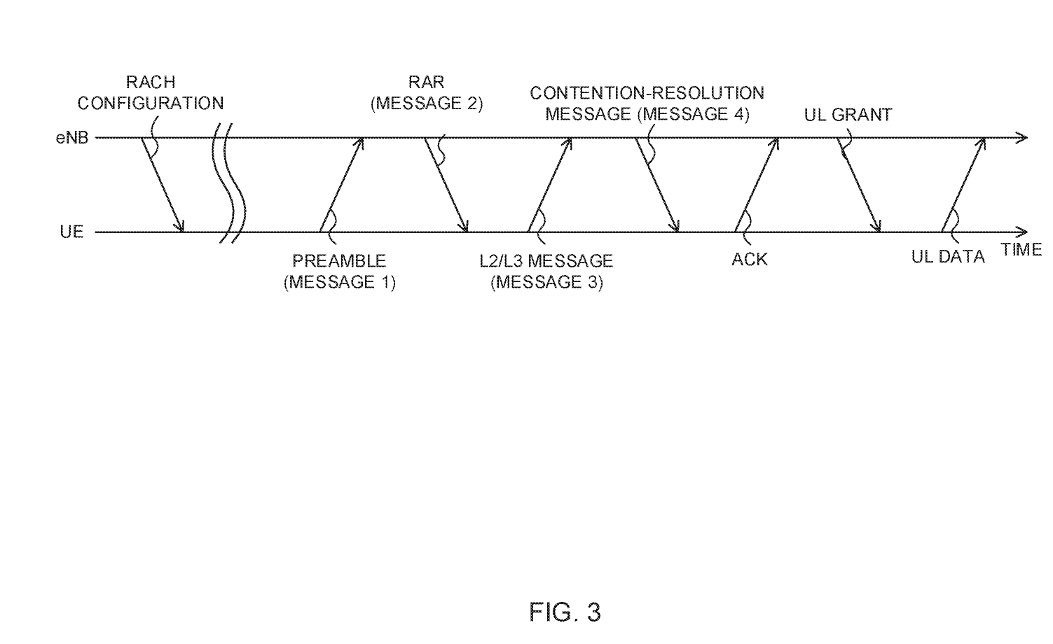

As shown in FIG. 3, when the user terminal transitions from idle mode (RRC_IDLE) to RRC-connected mode (RRC_CONNECTED) (for example, when gaining initial access), if UL synchronization is not established despite the fact that the user terminal is in RRC-connected mode (for example, when UL transmission is started or resumed), the user terminal can randomly select one of a plurality of preambles that are indicated in the PRACH configuration information, and transmit the selected preamble using the PRACH (message 1).

Upon detecting the preamble, the radio base station transmits a random access response (RAR) (message 2) in response to that. If the user terminal fails to receive a RAR within a given period (RAR window) after the preamble is transmitted, the user terminal increases the transmission power of the PRACH and transmits the preamble again (retransmission).

Upon receiving the RAR, the user terminal adjusts the transmission timing in the UL based on the timing advance (TA) that is included in the RAR, and establishes UL synchronization. Furthermore, the user terminal transmits a higher layer (L2/L3: layer 2/layer 3) control message (message 3) in the UL resource specified by the UL grant included in the RAR. This control message contains the user terminal's identifier (UE-ID).

The radio base station sends a contention-resolution message in response to the higher layer control message (message 4). The contention-resolution message is transmitted based on the above-mentioned user terminal identifier included in the control message. Upon successfully detecting the contention-resolution message, the user terminal transmits an HARQ (Hybrid Automatic Repeat reQuest)-based positive acknowledgment (ACK) to the radio base station. By this means, the user terminal in idle mode transitions to RRC-connected mode.

On the other hand, if the user terminal fails to detect the contention-resolution message, the user terminal judges that contention has occurred, reselects a preamble, and repeats the random access procedures from message 1 to message 4. When learning from an ACK from the user terminal that the contention has been resolved, the radio base station transmits a UL grant to the user terminal. The user terminal starts transmitting UL data using the UL resource allocated by the UL grant.

Using the above random access procedures, the user terminal gains initial access.

During initial access, the user terminal selects one PRACH configuration (or PRACH resource) from multiple PRACH configurations. Here, the user terminal may select a PRACH configuration based on the user terminal's situation (the use case, the environment, etc.). The situation of the user terminal may be represented by at least one of: the user terminal's capabilities (UE capabilities, UE category, service, numerology, etc.), and parameters that are configured for the user terminal and/or detected by the user terminal. The parameters may be at least one of the frequency, the system band, the subcarrier spacing, the number of DM-RS antenna ports, the cell structure, the moving speed of the user terminal, the received quality, the degree of fading variation, the Doppler shift and the Doppler spread.

For example, an RS pattern that shows the DM-RS for the DL data channel for transmitting message 2 is associated with a PRACH configuration.

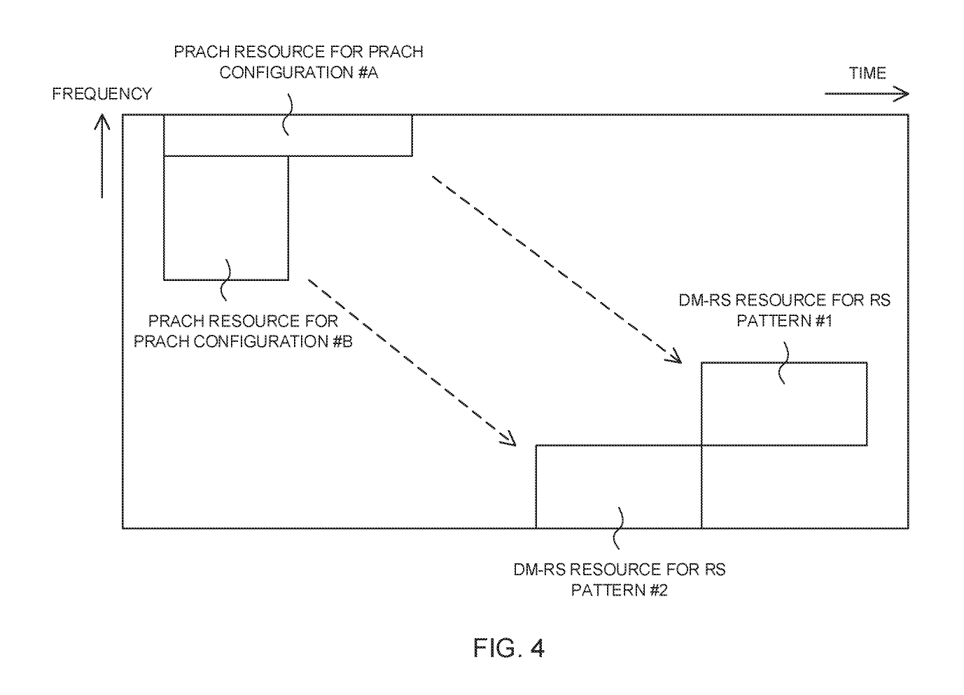

FIG. 4 is a diagram to show associations between PRACH configurations for transmitting message 1 and RS patterns for transmitting message 2. For example, upon initial access, the user terminal selects PRACH configuration #A when the received SINR is equal to or higher than a given value, and selects PRACH configuration #B when the received SINR is lower than the given value. Alternatively, the user terminal may select PRACH configuration #A when the coverage is greater than a given value, and select PRACH configuration #B when the coverage is smaller than the given value. After that, the user terminal transmits a random access preamble (also referred to as “message 1,” “PRACH,” etc.) using the selected PRACH configuration.

Each PRACH configuration indicates at least one of: multiple preambles (for example, preamble format), which are defined in each cell, the time resources that are used in PRACH transmission (including, for example, a system frame index, a subframe index and so on), and the offset to indicate the starting position of frequency resources (for example, six resource blocks).

For example, PRACH configuration #A does not repeat the preamble, but allocates a relatively short time resource and a relatively wide frequency resource to the PRACH. For example, PRACH configuration #B repeats the preamble, and allocates, to the PRACH, a longer time resource than in PRACH configuration #A and a narrower frequency resource than in PRACH configuration #A. When these PRACH configurations #A and #B are configured, the situation in which PRACH configuration #B is selected may be, in comparison with the situation in which PRACH configuration #A is selected, the case where the frequency is high, the case where the system bandwidth is wide, the case where the subcarrier spacing is narrow, the case where the number of transmit antenna ports is small, and the case where the moving speed is fast.

Note that, like the coverage enhancement (CE) level in eMTC (repetition level), multiple PRACH configurations may be defined based on the number of times a preamble is repeated, or may be associated with CE levels. Similarly to the CE level, the user terminal may select PRACH configurations based on parameters (measurement results) measured by the user terminal.

The radio base station waits to receive message 1 in multiple pre-configured PRACH configurations. Upon receiving message 1, the radio base station judges which PRACH configuration is used for message 1, and selects the RS pattern that corresponds to the identified PRACH configuration, from a plurality of pre-configured RS patterns. Referring to FIG. 4, RS pattern #1 is associated with PRACH configuration #A, and RS pattern #2 is associated with PRACH configuration #B.

After that, the radio base station transmits the DM-RS using the selected RS pattern, and, furthermore, transmits message 2 (RAR) in a DL data channel. The user terminal selects the RS pattern corresponding to the PRACH configuration that was used to transmit message 1, receives the DM-RS using the selected RS pattern, and, furthermore, receives message 2. Here, the user terminal performs channel estimation using the DM-RS and demodulates message 2 based on the result of channel estimation.

Although FIG. 4 shows a case where the radio base station and the user terminal use TDD (Time Division Duplex), FDD (Frequency Division Duplex) may be used as well.

Candidate information, which includes information about multiple PRACH configurations and information about the RS patterns associated with each PRACH configuration, may be reported to the user terminal in idle mode, using system information. In this case, the candidate information may be reported on a per cell basis, or per transmission and reception point (TRP).

For user terminals in RRC-connected mode, the candidate information may be reported using higher layer signaling and/or physical layer signaling (for example, DCI). In this case, the candidate information may be reported per user terminal.

Furthermore, the radio base station may select an RS pattern and RS pattern information (reference signal configuration information) that indicates this RS pattern, and report these by using higher layer signaling and/or physical layer signaling. For example, candidate information related to secondary cells (SCells) in CA (Carrier Aggregation) or DC (Dual Connectivity) may be reported to the user terminal through higher layer signaling. Note that, when the candidate information is reported in system information and in higher layer signaling, the content of the candidate information in higher layer signaling may be the same as the content of the candidate information in system information.

Furthermore, information about multiple PRACH configurations and information about the RS patterns associated to each PRACH configuration may be configured in the user terminal in advance.

The candidate information may include PRACH configuration information that indicates each PRACH configuration, or include RS pattern information that indicates each RS pattern. Each RS pattern may be associated with a PRACH configuration index that represents a PRACH configuration.

A common RS pattern may be used with at least one of messages 2, 3 or 4, and the DM-RS that applies to the DL control channel. Furthermore, a common RS pattern may be applied to the DM-RSs for a plurality of channels such as control channels and data channels. In this case, one common RS pattern may be associated with one PRACH configuration.

Also, different RS patterns may be used depending on messages and/or channels. For example, mutually different RS patterns may be used between UL message (for example, message 3) and DL messages (for example, messages 2 and 4). For example, when the DM-RS for the DL control channel is transmitted when message 2 is transmitted, the RS pattern of the DM-RS for the DL control channel may be different from the RS pattern of the DM-RS for the DL data channel. In this case, multiple RS patterns (for example, the RS pattern for the DL data channel and the RS pattern for the DL control channel) may be associated with one PRACH configuration. In addition, multiple RS patterns may be associated with multiple messages and/or channels, respectively.

DL signals to be transmitted after message 2 may be used to report RS pattern information that indicates the RS patterns that are going to be used later. For example, the RS pattern information for transmitting message 3 may be reported in message 2 (for example, in a UL grant in a RAR).

Also, after RS patterns are configured in the user terminal, the radio base station may select an RS pattern. In this case, after an RRC connection is established, the radio base station can report RS pattern information to indicate that RS pattern to the user terminal via higher layer signaling and/or physical layer signaling. This allows the radio base station to re-configure (replace) the RS patterns associated with the PRACH configurations. The radio base station may use a plurality of RS patterns that are configured as candidates prior to initial access as re-configured RS patterns, or provide new RS patterns apart from them.

When the radio base station judges the situation of the user terminal based on a number of times of transmission/receipt with the user terminal, the RS patterns are reconfigured after message 2, so that it is possible to use RS patterns that are suitable to the situation the user terminal is in, and improve the accuracy of channel estimation. For example, in multiple BF, after the radio base station selects an optimal beam by means of beam scanning, the radio base station may select an optimal RS pattern based on the selected beam, and reconfigure the selected RS pattern.

Note that a group to include a larger number of RS patterns than the candidate RS patterns may be configured in advance in the specification and so on. In this case, in the group, the RS pattern information may indicate the index of an RS pattern that is reported, or the index of the PRACH configuration that is associated in advance with an RS pattern that is reported.

The RS pattern information may include indices of symbols where the RS is mapped. PRB indices, subcarrier indices, the cycle, offsets and so on, or a bitmap to show the mapping of the RS. The RS pattern information may include information that shows the resources that are allocated to control channels and/or data channels.

Note that the RS pattern information may include the number of antenna ports assigned to DM-RSs. For example, the DL control channel can use more antenna ports than RARs. By including the number of DM-RS antenna ports in RS pattern information, it is possible to use the number of antenna ports suitable to the type of message, and improve the accuracy of channel estimation. Furthermore, the RS pattern information may show the antenna port numbers assigned to DM-RSs. or show the RS patterns that correspond to the antenna port numbers.

Furthermore, the RS pattern information may include the power ratio (EPRE: Energy Per Resource Element) between the DM-RS and the DL data channel. By including this power ratio in the RS pattern information and allowing the user terminal to demodulate the DL data channel based on channel estimation results and the power ratio, it is possible to improve the reliability of data demodulation. In particular, when the modulation scheme for message 2 is quadrature amplitude modulation such as 16QAM, the reliability of data demodulation can be improved.

Furthermore, the RS pattern information may include quasi-co-location information. When the user terminal performs the receiving process using reference signals transmitted from each transmission point, it is desirable to perform the receiving process taking into consideration the geographical location of each transmission point (the channel characteristics of downlink signals transmitted from each transmission point). Therefore, a study in progress, in which, if different antenna ports (APs) share the same long-term channel characteristics, these antenna ports are assumed to be “quasi-co-located” (have the same geographical relationship), and the user terminal performs different receiving processes depending on whether or not a plurality of downlink signals hold a quasi-co-location relationship. When DM-RSs are transmitted from two APs that are judged to be geographically apart (that is, not quasi-co-located), the user terminal performs channel estimation independently for each of these two APs.

Quasi-co-location information may be the result of judging quasi-co-location, or may be information that is for use in judging quasi-co-location, such as long-term channel characteristics. In addition, the RS pattern information may include quasi-co-location information pertaining to DM-RSs and quasi-co-location information pertaining to DL data channels.

By including quasi-co-location information in RS pattern information, it is possible to perform channel estimation and/or the demodulation process in accordance with each transmission point, so that the accuracy of channel estimation and reliability of data demodulation can be improved.

When a user terminal in RRC-connected mode (RRC_CONNECTED) has to transmit a PRACH due to loss of synchronization and/or the like, the user terminal may use the RS pattern determined in initial access, without changing the RS pattern.

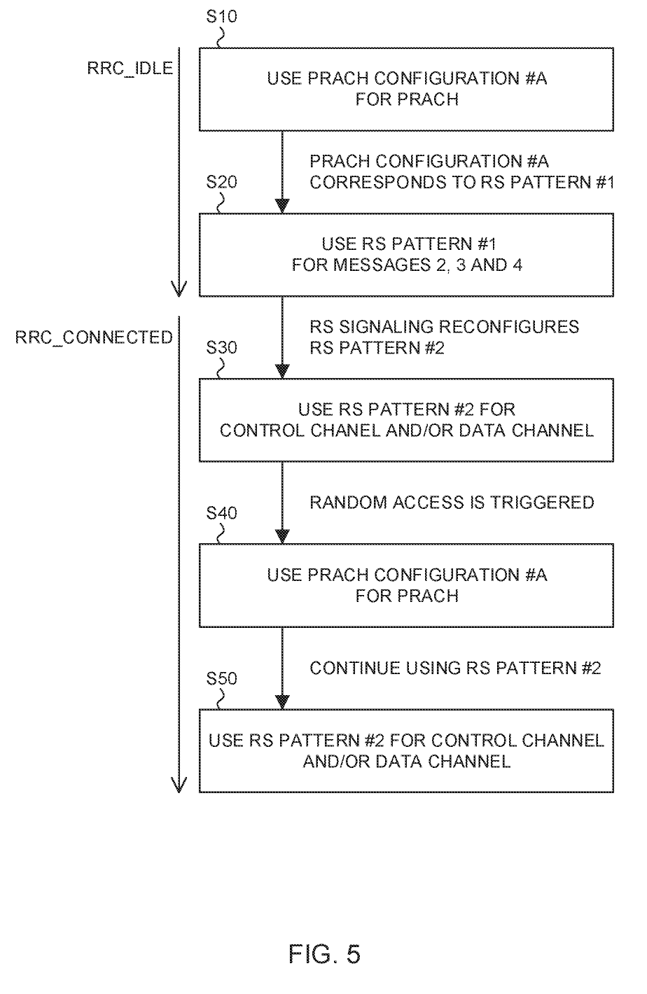

FIG. 5 is a diagram to show the random access operation by the user terminal.

When the user terminal tries to gain initial access in idle mode (RRC_IDLE), the user terminal selects PRACH configuration #A based on the situation of the user terminal, and transmits message 1 using PRACH configuration #A (step S10).

After that, the user terminal selects RS pattern #1 that corresponds to PRACH configuration #A. and, using RS pattern #1, the user terminal receives message 2, transmits message 3, receives message 4, and establishes an RRC connection (step S20). By this means, the mode of the user terminal transitions from idle mode to RRC-connected mode (RRC_CONNECTED).

The radio base station decides to use RS pattern #2 based on the situation of the user terminal, and reports (re-configures) RS pattern #2 to the user terminal via RRC signaling. By this means, the radio base station and the user terminal thereafter apply RS pattern #2 to the DM-RSs for the control channel and/or the data channel (step S30).

After that, when random access is triggered, the user terminal selects PRACH configuration #A based on the situation of the user terminal, as in initial access, and transmits message 1 using PRACH configuration #A (step S40). Random access may be triggered by the user terminal in response to loss of UL synchronization or other similar events, or may be triggered by the radio base station through a DL control channel.

After that, the radio base station and the user terminal do not apply RS pattern #1, which corresponds to PRACH configuration #A, to the DM-RSs for the subsequent random access procedures and for control channels and/or data channels, but apply RS pattern #2, which was before random access (step S50).

As shown in the above operations, if random access is triggered after the RS pattern is reconfigured, the user terminal gains this random access using the reconfigured RS pattern, so that it is possible to improve the accuracy of channel estimation during this random access. In particular, when the radio base station judges the situation of the user terminal based on transmission and receipt with the user terminal as when beam scanning is performed in the multiple BF operation, given that the accuracy of channel estimation decreases until the radio base station reconfigures the RS pattern, it is effective to gain random access by using an RS pattern that is already reconfigured.

(Radio Communication System)

Now, the structure of the radio communication system according to one embodiment of the present invention will be described below. In this radio communication system, communication is performed using one or a combination of the radio communication methods according to the herein-contained embodiments of the present invention.

FIG. 6 is a diagram to show an example of a schematic structure of a radio communication system according to one embodiment of the present invention. A radio communication system 1 can adopt carrier aggregation (CA) and/or dual connectivity (DC) to group a plurality of fundamental frequency blocks (component carriers) into one, where the LTE system bandwidth (for example, 20 MHz) constitutes one unit.

Note that the radio communication system 1 may be referred to as “LTE (Long Term Evolution),” “LTE-A (LTE-Advanced),” “LTE-B (LTE-Beyond),” “SUPER 3G,” “IMT-Advanced,” “4G (4th generation mobile communication system),” “5G (5th generation mobile communication system),” “FRA (Future Radio Access),” “New-RAT (Radio Access Technology)” and so on, or may be seen as a system to implement these.

The radio communication system 1 includes a radio base station 11 that forms a macro cell C1 having a relatively wide coverage, and radio base stations 12 (12a to 12c) that are placed within the macro cell C1 and that form small cells C2, which are narrower than the macro cell C1. Also, user terminals 20 are placed in the macro cell C1 and in each small cell C2. The arrangement of cells and user terminals 20 are not limited to those shown in the drawings.

The user terminals 20 can connect with both the radio base station 11 and the radio base stations 12. The user terminals 20 may use the macro cell C1 and the small cells C2 at the same time by means of CA or DC. Furthermore, the user terminals 20 may apply CA or DC using a plurality of cells (CCs) (for example, five or fewer CCs or six or more CCs).

Between the user terminals 20 and the radio base station 11, communication can be carried out using a carrier of a relatively low frequency band (for example, 2 GHz) and a narrow bandwidth (referred to as, for example, an “existing carrier,” a “legacy carrier” and so on). Meanwhile, between the user terminals 20 and the radio base stations 12, a carrier of a relatively high frequency band (for example, 3.5 GHz, 5 GHz and so on) and a wide bandwidth may be used, or the same carrier as that used in the radio base station 11 may be used. Note that the structure of the frequency band for use in each radio base station is by no means limited to these.

A structure may be employed here in which wire connection (for example, means in compliance with the CPRI (Common Public Radio Interface) such as optical fiber, the X2 interface and so on) or wireless connection is established between the radio base station 11 and the radio base station 12 (or between two radio base stations 12).

The radio base station 11 and the radio base stations 12 are each connected with higher station apparatus 30, and are connected with a core network 40 via the higher station apparatus 30. Note that the higher station apparatus 30 may be, for example, access gateway apparatus, a radio network controller (RNC), a mobility management entity (MME) and so on, but is by no means limited to these. Also, each radio base station 12 may be connected with the higher station apparatus 30 via the radio base station 11.

Note that the radio base station 11 is a radio base station having a relatively wide coverage, and may be referred to as a “macro base station,” a “central node,” an “eNB (eNodeB).” a “transmitting/receiving point” and so on. Also, the radio base stations 12 are radio base stations having local coverages, and may be referred to as “small base stations,” “micro base stations,” “pico base stations,” “femto base stations,” “HeNBs (Home eNodeBs),” “RRHs (Remote Radio Heads),” “transmitting/receiving points” and so on. Hereinafter the radio base stations 11 and 12 will be collectively referred to as “radio base stations 10.” unless specified otherwise.

The user terminals 20 are terminals to support various communication schemes such as LTE, LTE-A and so on, and may be either mobile communication terminals (mobile stations) or stationary communication terminals (fixed stations).

In the radio communication system 1, as radio access schemes, orthogonal frequency division multiple access (OFDMA) is applied to the downlink, and single-carrier frequency division multiple access (SC-FDMA) is applied to the uplink.

OFDMA is a multi-carrier communication scheme to perform communication by dividing a frequency bandwidth into a plurality of narrow frequency bandwidths (subcarriers) and mapping data to each subcarrier. SC-FDMA is a single-carrier communication scheme to mitigate interference between terminals by dividing the system bandwidth into bands formed with one or continuous resource blocks per terminal, and allowing a plurality of terminals to use mutually different bands. Note that the uplink and downlink radio access schemes are not limited to these combinations, and other radio access schemes may be used.

In the radio communication system 1, a downlink shared channel (PDSCH: Physical Downlink Shared CHannel), which is used by each user terminal 20 on a shared basis, a broadcast channel (PBCH: Physical Broadcast CHannel), downlink L1/L2 control channels and so on are used as downlink channels. User data, higher layer control information and SIBs (System Information Blocks) are communicated in the PDSCH. Also, the MIB (Master Information Block) is communicated in the PBCH.

The downlink L1/L2 control channels include a PDCCH (Physical Downlink Control CHannel), an EPDCCH (Enhanced Physical Downlink Control CHannel), a PCFICH (Physical Control Format Indicator CHannel), a PHICH (Physical Hybrid-ARQ Indicator CHannel) and so on. Downlink control information (DCI), including PDSCH and PUSCH scheduling information, is communicated by the PDCCH. The number of OFDM symbols to use for the PDCCH is communicated by the PCFICH. HARQ (Hybrid Automatic Repeat reQuest) delivery acknowledgment information (also referred to as, for example, “retransmission control information.” “HARQ-ACKs.” “ACK/NACKs,” etc.) in response to the PUSCH is transmitted by the PHICH. The EPDCCH is frequency-division-multiplexed with the PDSCH (downlink shared data channel) and used to communicate DCI and so on, like the PDCCH.

In the radio communication system 1, an uplink shared channel (PUSCH: Physical Uplink Shared CHannel), which is used by each user terminal 20 on a shared basis, an uplink control channel (PUCCH: Physical Uplink Control CHannel), a random access channel (PRACH: Physical Random Access CHannel) and so on are used as uplink channels. User data, higher layer control information and so on are communicated by the PUSCH. Also, downlink radio quality information (CQI: Channel Quality Indicator), delivery acknowledgement information and so on are communicated by the PUCCH. By means of the PRACH, random access preambles for establishing connections with cells are communicated.

In the radio communication systems 1, the cell-specific reference signal (CRS: Cell-specific Reference Signal), the channel state information reference signal (CSI-RS: Channel State Information-Reference Signal), the demodulation reference signal (DMRS: DeModulation Reference Signal), the positioning reference signal (PRS: Positioning Reference Signal) and so on are communicated as downlink reference signals. Also, in the radio communication system 1, the measurement reference signal (SRS: Sounding Reference Signal), the demodulation reference signal (DMRS) and so on are communicated as uplink reference signals. Note that the DMRS may be referred to as a “user terminal-specific reference signal (UE-specific Reference Signal).” Also, the reference signals to be communicated are by no means limited to these.

(Radio Base Station)

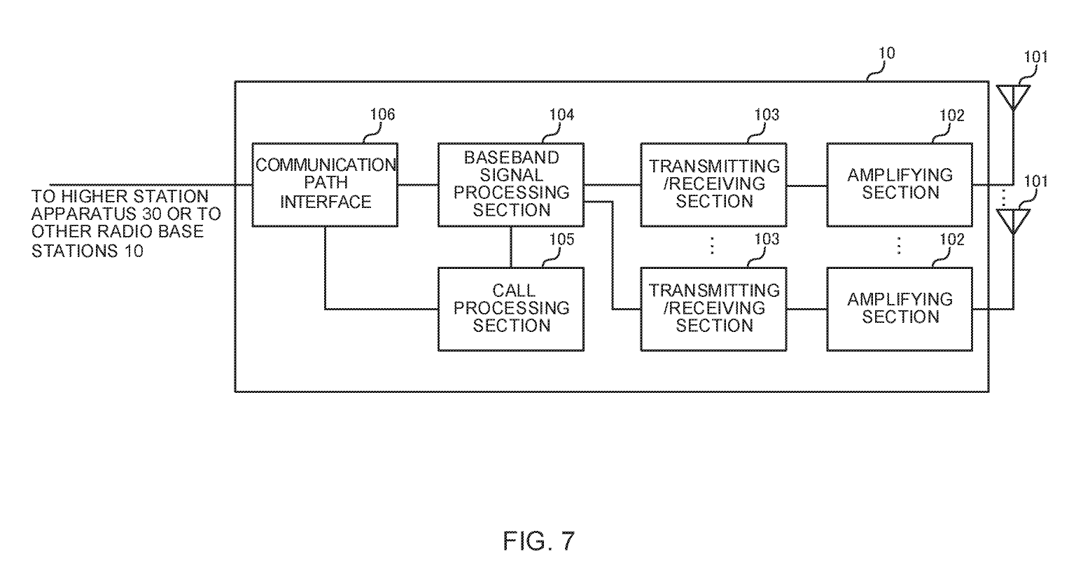

FIG. 7 is a diagram to show an example of an overall structure of a radio base station according to one embodiment of the present invention. A radio base station 10 has a plurality of transmitting/receiving antennas 101, amplifying sections 102, transmitting/receiving sections 103, a baseband signal processing section 104, a call processing section 105 and a communication path interface 106. Note that one or more transmitting/receiving antennas 101, amplifying sections 102 and transmitting/receiving sections 103 may be provided.

User data to be transmitted from the radio base station 10 to a user terminal 20 on the downlink is input from the higher station apparatus 30 to the baseband signal processing section 104, via the communication path interface 106.

In the baseband signal processing section 104, the user data is subjected to a PDCP (Packet Data Convergence Protocol) layer process, user data division and coupling. RLC (Radio Link Control) layer transmission processes such as RLC retransmission control, MAC (Medium Access Control) retransmission control (for example, an HARQ (Hybrid Automatic Repeat reQuest) transmission process), scheduling, transport format selection, channel coding, an inverse fast Fourier transform (IFFT) process and a precoding process, and the result is forwarded to each transmitting/receiving section 103. Furthermore, downlink control signals are also subjected to transmission processes such as channel coding and an inverse fast Fourier transform, and forwarded to each transmitting/receiving section 103.

Baseband signals that are precoded and output from the baseband signal processing section 104 on a per antenna basis are converted into a radio frequency band in the transmitting/receiving sections 103, and then transmitted. The radio frequency signals having been subjected to frequency conversion in the transmitting/receiving sections 103 are amplified in the amplifying sections 102, and transmitted from the transmitting/receiving antennas 101. The transmitting/receiving sections 103 can be constituted by transmitters/receivers, transmitting/receiving circuits or transmitting/receiving apparatus that can be described based on general understanding of the technical field to which the present invention pertains. Note that a transmitting/receiving section 103 may be structured as a transmitting/receiving section in one entity, or may be constituted by a transmitting section and a receiving section.

Meanwhile, as for uplink signals, radio frequency signals that are received in the transmitting/receiving antennas 101 are each amplified in the amplifying sections 102. The transmitting/receiving sections 103 receive the uplink signals amplified in the amplifying sections 102. The received signals are converted into the baseband signal through frequency conversion in the transmitting/receiving sections 103 and output to the baseband signal processing section 104.

In the baseband signal processing section 104, user data that is included in the uplink signals that are input is subjected to a fast Fourier transform (FFT) process, an inverse discrete Fourier transform (IDFT) process, error correction decoding, a MAC retransmission control receiving process, and RLC layer and PDCP layer receiving processes, and forwarded to the higher station apparatus 30 via the communication path interface 106. The call processing section 105 performs call processing (such as setting up and releasing communication channels), manages the state of the radio base stations 10 and manages the radio resources.

The communication path interface section 106 transmits and receives signals to and from the higher station apparatus 30 via a given interface. Also, the communication path interface 106 may transmit and receive signals (backhaul signaling) with other radio base stations 10 via an inter-base station interface (which is, for example, optical fiber that is in compliance with the CPRI (Common Public Radio Interface), the X2 interface, etc.).

Note that the transmitting/receiving sections 103 may furthermore have an analog beam forming section that forms analog beams. The analog beam forming section may be constituted by an analog beam forming circuit (for example, a phase shifter, a phase shifting circuit, etc.) or analog beam forming apparatus (for example, a phase shifting device) that can be described based on general understanding of the technical field to which the present invention pertains. Furthermore, the transmitting/receiving antennas 101 may be constituted by, for example, array antennas. In addition, the transmitting/receiving sections 103 are structured so that single-BF or multiple-BF operations can be used.

In addition, the transmitting/receiving sections 103 transmit a DL reference signal using a resource indicated in a reference signal configuration. In addition, the transmitting/receiving sections 103 may receive a UL reference signal using the resource indicated in reference signal configuration. In addition, the transmitting/receiving section 103 may transmit reference signal configuration information, which shows the reference signal configuration, to the user terminal 20.

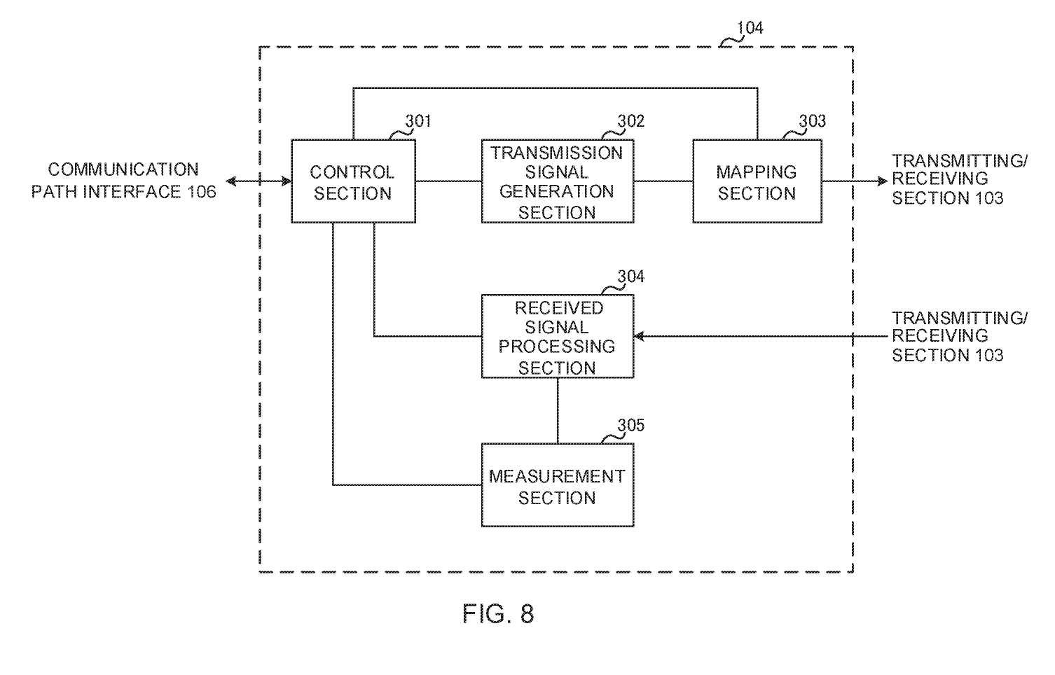

FIG. 8 is a diagram to show an example of functional structure of a radio base station according to one embodiment of the present invention. Note that, although this example primarily shows functional blocks that pertain to characteristic parts of the present embodiment, the radio base station 10 has other functional blocks that are necessary for radio communication as well.

The baseband signal processing section 104 has a control section (scheduler) 301, a transmission signal generation section 302, a mapping section 303, a received signal processing section 304 and a measurement section 305. Note that these configurations have only to be included in the radio base station 10, and some or all of these configurations may not be included in the baseband signal processing section 104.

The control section (scheduler) 301 controls the whole of the radio base station 10. The control section 301 can be constituted by a controller, a control circuit or control apparatus that can be described based on general understanding of the technical field to which the present invention pertains.

The control section 301, for example, controls the generation of signals in the transmission signal generation section 302, the allocation of signals by the mapping section 303, and so on. Furthermore, the control section 301 controls the signal receiving processes in the received signal processing section 304, the measurements of signals in the measurement section 305, and so on.

The control section 301 controls the scheduling (for example, resource allocation) of system information, downlink data signals (for example, signals transmitted in the PDSCH) and downlink control signals (for example, signals communicated in the PDSCH and/or the EPDCCH). Also, the control section 301 controls the generation of downlink control signals (for example, delivery acknowledgement information and so on), downlink data signals and so on, based on whether or not retransmission control is necessary, which is decided in response to uplink data signals, and so on. Also, the control section 301 controls the scheduling of synchronization signals (for example, the PSS (Primary Synchronization Signal)/SSS (Secondary Synchronization Signal)), downlink reference signals (for example, the CRS, the CSI-RS, the DMRS, etc.) and so on.

In addition, the control section 301 controls the scheduling of uplink data signals (for example, signals transmitted in the PUSCH), uplink control signals (for example, signals transmitted in the PUCCH and/or the PUSCH), random access preambles transmitted in the PRACH, uplink reference signals, and so on.

Furthermore, the control section 301 controls the receipt of a PRACH based on a plurality of PRACH configurations. The control section 301 identifies the PRACH configuration used for the PRACH that is received, selects the reference signal configuration corresponding to the identified PRACH configuration, and controls the scheduling of the reference signal based on the selected reference signal configuration.

Furthermore, the control section 301 may judge the situation of the user terminal 20 based on information received from the user terminal 20, reconfigure the reference signal configuration based on the judged result, and report reference signal configuration information indicating this reference signal configuration to the user terminal 20.

The transmission signal generation section 302 generates downlink signals (downlink control signals, downlink data signals, downlink reference signals and so on) based on commands from the control section 301, and outputs these signals to the mapping section 303. The transmission signal generation section 302 can be constituted by a signal generator, a signal generating circuit or signal generating apparatus that can be described based on general understanding of the technical field to which the present invention pertains.

For example, the transmission signal generation section 302 generates DL assignments, which report downlink signal allocation information, and UL grants, which report uplink signal allocation information, based on commands from the control section 301. Also, the downlink data signals are subjected to the coding process, the modulation process and so on, by using coding rates and modulation schemes that are determined based on, for example, channel state information (CSI) from each user terminal 20.

The mapping section 303 maps the downlink signals generated in the transmission signal generation section 302 to given radio resources based on commands from the control section 301, and outputs these to the transmitting/receiving sections 103. The mapping section 303 can be constituted by a mapper, a mapping circuit or mapping apparatus that can be described based on general understanding of the technical field to which the present invention pertains.

The received signal processing section 304 performs receiving processes (for example, demapping, demodulation, decoding and so on) of received signals that are input from the transmitting/receiving sections 103. Here, the received signals include, for example, uplink signals transmitted from the user terminals 20 (uplink control signals, uplink data signals, uplink reference signals and so on). For the received signal processing section 304, a signal processor, a signal processing circuit or signal processing apparatus that can be described based on general understanding of the technical field to which the present invention pertains can be used.

The received signal processing section 304 outputs the decoded information acquired through the receiving processes to the control section 301. For example, when a PUCCH to contain an HARQ-ACK is received, the received signal processing section 304 outputs this HARQ-ACK to the control section 301. Also, the received signal processing section 304 outputs the received signals and/or the signals after the receiving processes to the measurement section 305.

The measurement section 305 conducts measurements with respect to the received signals. The measurement section 305 can be constituted by a measurer, a measurement circuit or measurement apparatus that can be described based on general understanding of the technical field to which the present invention pertains.

For example, the measurement section 305 may perform RRM (Radio Resource Management) measurements. CSI (Channel State Information) measurements and so on, based on the received signals. The measurement section 305 may measure the received power (for example, RSRP (Reference Signal Received Power)), the received quality (for example, RSRQ (Reference Signal Received Quality). SINR (Signal to Interference plus Noise Ratio), etc.), the power strength (for example, RSSI (Received Signal Strength Indicator)), uplink channel information (for example, CSI) and so on. The measurement results may be output to the control section 301.

(User Terminal)

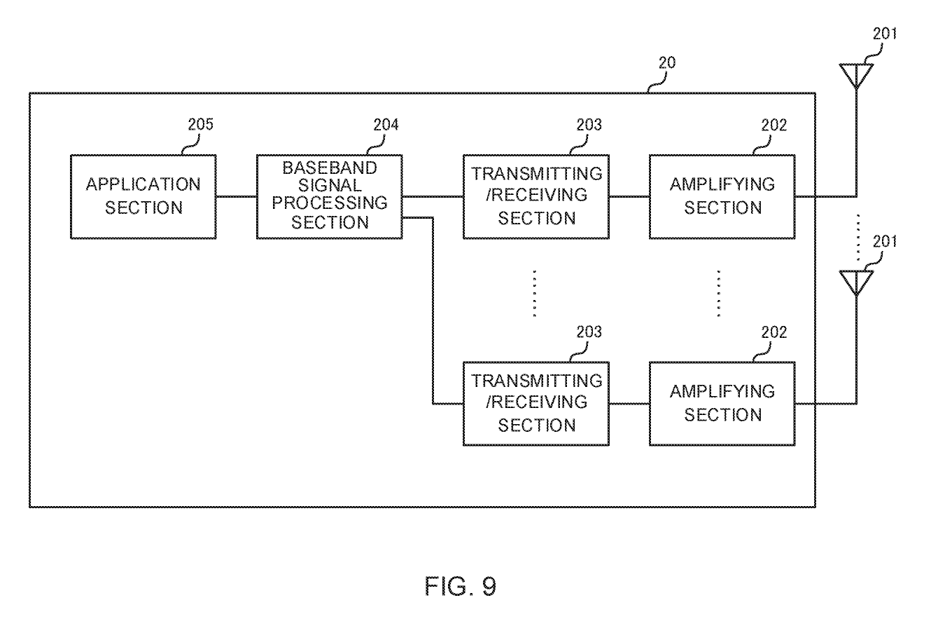

FIG. 9 is a diagram to show an example of an overall structure of a user terminal according to one embodiment of the present invention. A user terminal 20 has a plurality of transmitting/receiving antennas 201, amplifying sections 202, transmitting/receiving sections 203, a baseband signal processing section 204 and an application section 205. Note that one or more transmitting/receiving antennas 201, amplifying sections 202 and transmitting/receiving sections 203 may be provided.

Radio frequency signals that are received in the transmitting/receiving antennas 201 are amplified in the amplifying sections 202. The transmitting/receiving sections 203 receive the downlink signals amplified in the amplifying sections 202. The received signals are subjected to frequency conversion and converted into the baseband signal in the transmitting/receiving sections 203, and output to the baseband signal processing section 204. A transmitting/receiving section 203 can be constituted by a transmitters/receiver, a transmitting/receiving circuit or transmitting/receiving apparatus that can be described based on general understanding of the technical field to which the present invention pertains. Note that a transmitting/receiving section 203 may be structured as a transmitting/receiving section in one entity, or may be constituted by a transmitting section and a receiving section.

In the baseband signal processing section 204, the baseband signal that is input is subjected to an FFT process, error correction decoding, a retransmission control receiving process, and so on. Downlink user data is forwarded to the application section 205. The application section 205 performs processes related to higher layers above the physical layer and the MAC layer, and so on. Also, among the downlink data, the broadcast information may also be forwarded to the application section 205.

Meanwhile, uplink user data is input from the application section 205 to the baseband signal processing section 204. The baseband signal processing section 204 performs a retransmission control transmission process (for example, an HARQ transmission process), channel coding, precoding, a discrete Fourier transform (DFT) process, an IFFT process and so on, and the result is forwarded to the transmitting/receiving sections 203. Baseband signals that are output from the baseband signal processing section 204 are converted into a radio frequency band in the transmitting/receiving sections 203 and transmitted. The radio frequency signals that are subjected to frequency conversion in the transmitting/receiving sections 203 are amplified in the amplifying sections 202, and transmitted from the transmitting/receiving antennas 201.

Note that the transmitting/receiving sections 203 may furthermore have an analog beam forming section that forms analog beams. The analog beam forming section may be constituted by an analog beam forming circuit (for example, a phase shifter, a phase shifting circuit, etc.) or analog beam forming apparatus (for example, a phase shifting device) that can be described based on general understanding of the technical field to which the present invention pertains. Furthermore, the transmitting/receiving antennas 201 may be constituted by, for example, array antennas. In addition, the transmitting/receiving sections 203 are structured so as to be capable of single-BF and multiple-BF operations.

In addition, the transmitting/receiving sections 203 transmit a PRACH. In addition, the transmitting/receiving sections 203 receive a DL reference signal using a resource indicated in a reference signal configuration. In addition, the transmitting/receiving sections 203 may transmit a UL reference signal using the resource indicated in the reference signal configuration. Also, after transmitting the PRACH, the transmitting/receiving sections 203 may receive information related to a second reference signal configuration. Also, in random access procedures that take place after the information related to the second reference signal configuration is received, the transmitting/receiving sections 203 may receive the reference signal in accordance with the second reference signal configuration.

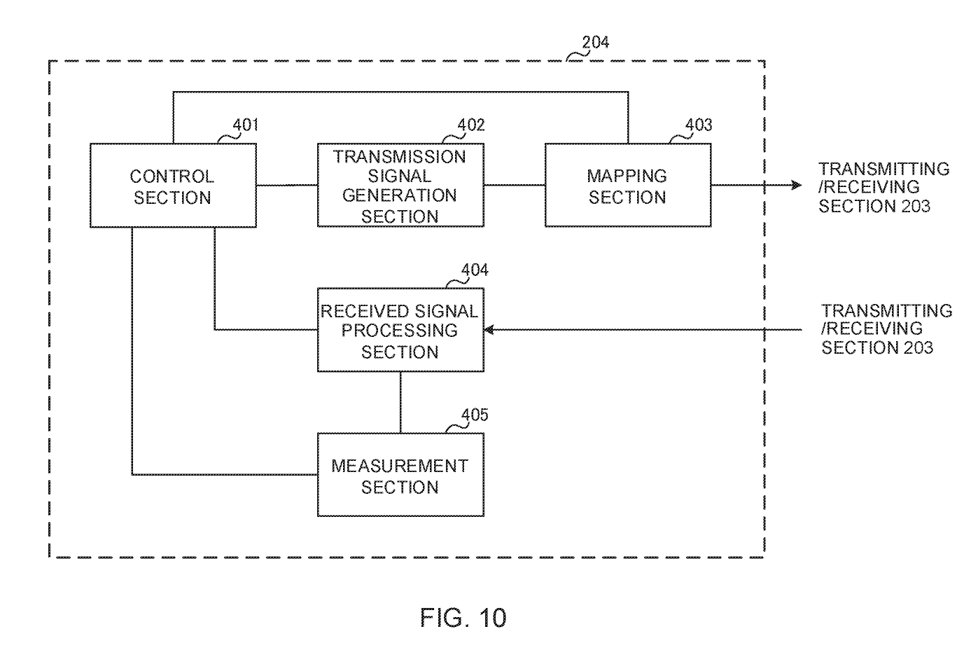

FIG. 10 is a diagram to show an example of a functional structure of a user terminal according to one embodiment of the present invention. Note that, although this example primarily shows functional blocks that pertain to characteristic parts of the present embodiment, the user terminal 20 has other functional blocks that are necessary for radio communication as well.

The baseband signal processing section 204 provided in the user terminal 20 at least has a control section 401, a transmission signal generation section 402, a mapping section 403, a received signal processing section 404 and a measurement section 405. Note that these configurations have only to be included in the user terminal 20, and some or all of these configurations may not be included in the baseband signal processing section 204.

The control section 401 controls the whole of the user terminal 20. For the control section 401, a controller, a control circuit or control apparatus that can be described based on general understanding of the technical field to which the present invention pertains can be used.

The control section 401, for example, controls the generation of signals in the transmission signal generation section 402, the allocation of signals in the mapping section 403, and so on. Furthermore, the control section 401 controls the signal receiving processes in the received signal processing section 404, the measurements of signals in the measurement section 405, and so on.

The control section 401 acquires downlink control signals (for example, signals transmitted in the PDCCH/EPDCCH) and downlink data signals (for example, signals transmitted in the PDSCH) transmitted from the radio base station 10, via the received signal processing section 404. The control section 401 controls the generation of uplink control signals (for example, delivery acknowledgement information and so on) and/or uplink data signals based on whether or not retransmission control is necessary, which is decided in response to downlink control signals and/or downlink data signals, and so on.

The control section 401 may control forming of transmitting beams and/or receiving beams using digital BF (for example, precoding) by the baseband signal processing section 204 and/or analog BF (for example, phase rotation) by the transmitting/receiving sections 203.

Furthermore, the control section 401 selects a specific PRACH configuration from a plurality of PRACH configurations, which are respectively associated with a plurality of reference signal configurations for use in transmitting DL reference signals. Furthermore, the control section 401 controls the transmission of PRACH by applying specific PRACH configurations.

In addition, the control section 401 may control reception of information about multiple PRACH configurations and information about the reference signal configurations that are associated with each PRACH configuration. In addition, the control section 401 may control reception of a DL reference signal based on a first reference signal configuration that corresponds to a specific PRACH configuration. Also, when transmitting a UL reference signal, the control section 401 may control the transmission of the UL reference signal by applying a reference signal configuration that is associated with a specific PRACH configuration or by applying a reference signal configuration that is reported separately. Also, if, after the PRACH is transmitted, information related to a second reference signal configuration is received, the control section 401 may control the receipt of the DL reference signal based on the second reference signal configuration.

The transmission signal generation section 402 generates uplink signals (uplink control signals, uplink data signals, uplink reference signals and so on) based on commands from the control section 401, and outputs these signals to the mapping section 403. The transmission signal generation section 402 can be constituted by a signal generator, a signal generating circuit or signal generating apparatus that can be described based on general understanding of the technical field to which the present invention pertains.

For example, the transmission signal generation section 402 generates uplink control signals related to delivery acknowledgement information, channel state information (CSI) and so on, based on commands from the control section 401. Also, the transmission signal generation section 402 generates uplink data signals based on commands from the control section 401. For example, when a UL grant is included in a downlink control signal that is reported from the radio base station 10, the control section 401 commands the transmission signal generation section 402 to generate an uplink data signal.

The mapping section 403 maps the uplink signals generated in the transmission signal generation section 402 to radio resources based on commands from the control section 401, and outputs the result to the transmitting/receiving sections 203. The mapping section 403 can be constituted by a mapper, a mapping circuit or mapping apparatus that can be described based on general understanding of the technical field to which the present invention pertains.

The received signal processing section 404 performs receiving processes (for example, demapping, demodulation, decoding and so on) of received signals that are input from the transmitting/receiving sections 203. Here, the received signals include, for example, downlink signals (downlink control signals, downlink data signals, downlink reference signals and so on) that are transmitted from the radio base station 10. The received signal processing section 404 can be constituted by a signal processor, a signal processing circuit or signal processing apparatus that can be described based on general understanding of the technical field to which the present invention pertains. Also, the received signal processing section 404 can constitute the receiving section according to the present invention.

The received signal processing section 404 outputs the decoded information, acquired through the receiving processes, to the control section 401. The received signal processing section 404 outputs, for example, broadcast information, system information, RRC signaling, DCI and so on, to the control section 401. Also, the received signal processing section 404 outputs the received signals and/or the signals after the receiving processes to the measurement section 405.

The measurement section 405 conducts measurements with respect to the received signals. For example, the measurement section 405 performs measurements using downlink reference signals transmitted from the radio base station 10. The measurement section 405 can be constituted by a measurer, a measurement circuit or measurement apparatus that can be described based on general understanding of the technical field to which the present invention pertains.

For example, the measurement section 405 may perform RRM measurements. CSI measurements and so on based on received signals. The measurement section 405 may measure the received power (for example, RSRP), the received quality (for example, RSRQ. SINR, etc.), the power strength (for example, RSSI), downlink channel information (for example, CSI), and so on. The measurement results may be output to the control section 401.

(Hardware Structure)

Note that the block diagrams that have been used to describe the above embodiments show blocks in functional units. These functional blocks (components) may be implemented in arbitrary combinations of hardware and/or software. Also, the means for implementing each functional block is not particularly limited. That is, each functional block may be realized by one piece of apparatus that is physically and/or logically aggregated, or may be realized by directly and/or indirectly connecting two or more physically and/or logically separate pieces of apparatus (via wire or wireless, for example) and using these multiple pieces of apparatus.

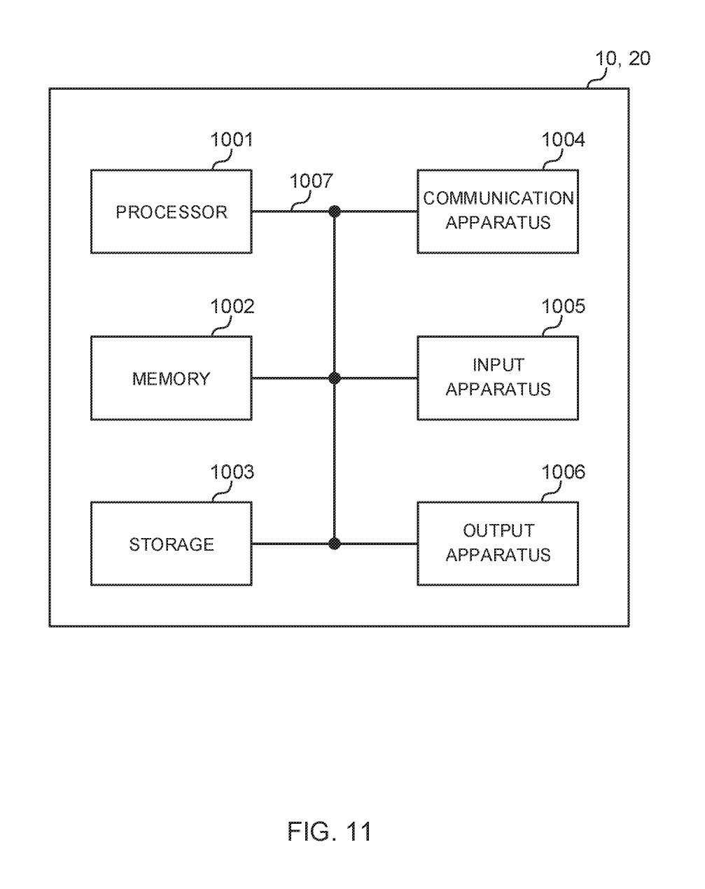

For example, the radio base station, user terminals and so on according to embodiments of the present invention may function as a computer that executes the processes of the radio communication method of the present invention. FIG. 11 is a diagram to show an example hardware structure of a radio base station and a user terminal according to one embodiment of the present invention. Physically, the above-described radio base stations 10 and user terminals 20 may be formed as a computer apparatus that includes a processor 1001, a memory 1002, a storage 1003, communication apparatus 1004, input apparatus 1005, output apparatus 1006And a bus 1007.

Note that, in the following description, the word “apparatus” may be replaced by “circuit,” “device,” “unit” and so on. Note that the hardware structure of a radio base station 10 and a user terminal 20 may be designed to include one or more of each apparatus shown in the drawings, or may be designed not to include part of the apparatus.

For example, although only one processor 1001 is shown, a plurality of processors may be provided. Furthermore, processes may be implemented with one processor, or processes may be implemented in sequence, or in different manners, on two or more processors. Note that the processor 1001 may be implemented with one or more chips.

Each function of the radio base station 10 and the user terminal 20 is implemented by reading given software (program) on hardware such as the processor 1001 and the memory 1002, and by controlling the calculations in the processor 1001, the communication in the communication apparatus 1004, and the reading and/or writing of data in the memory 1002 and the storage 1003.

The processor 1001 may control the whole computer by, for example, running an operating system. The processor 1001 may be configured with a central processing unit (CPU), which includes interfaces with peripheral apparatus, control apparatus, computing apparatus, a register and so on. For example, the above-described baseband signal processing section 104 (204), call processing section 105 and so on may be implemented by the processor 1001.

Furthermore, the processor 1001 reads programs (program codes), software modules or data, from the storage 1003 and/or the communication apparatus 1004, into the memory 1002, and executes various processes according to these. As for the programs, programs to allow computers to execute at least part of the operations of the above-described embodiments may be used. For example, the control section 401 of the user terminals 20 may be implemented by control programs that are stored in the memory 1002 and that operate on the processor 1001, and other functional blocks may be implemented likewise.

The memory 1002 is a computer-readable recording medium, and may be constituted by, for example, at least one of a ROM (Read Only Memory), an EPROM (Erasable Programmable ROM), an EEPROM (Electrically EPROM), a RAM (Random Access Memory) and/or other appropriate storage media. The memory 1002 may be referred to as a “register,” a “cache,” a “main memory” (primary storage apparatus) and so on. The memory 1002 can store executable programs (program codes), software modules and/or the like for implementing the radio communication methods according to embodiments of the present invention.

The storage 1003 is a computer-readable recording medium, and may be constituted by, for example, at least one of a flexible disk, a floppy (registered trademark) disk, a magneto-optical disk (for example, a compact disc (CD-ROM (Compact Disc ROM) and so on), a digital versatile disc, a Blu-ray (registered trademark) disk), a removable disk, a hard disk drive, a smart card, a flash memory device (for example, a card, a stick, a key drive, etc.), a magnetic stripe, a database, a server, and/or other appropriate storage media. The storage 1003 may be referred to as “secondary storage apparatus.”

The communication apparatus 1004 is hardware (transmitting/receiving device) for allowing inter-computer communication by using wired and/or wireless networks, and may be referred to as, for example, a “network device,” a “network controller.” a “network card,” a “communication module” and so on. The communication apparatus 1004 may be configured to include a high frequency switch, a duplexer, a filter, a frequency synthesizer and so on in order to realize, for example, frequency division duplex (FDD) and/or time division duplex (TDD). For example, the above-described transmitting/receiving antennas 101 (201), amplifying sections 102 (202), transmitting/receiving sections 103 (203), communication path interface 106 and so on may be implemented by the communication apparatus 1004.

The input apparatus 1005 is an input device for receiving input from the outside (for example, a keyboard, a mouse, a microphone, a switch, a button, a sensor and so on). The output apparatus 1006 is an output device for allowing sending output to the outside (for example, a display, a speaker, an LED (Light Emitting Diode) lamp and so on). Note that the input apparatus 1005 and the output apparatus 1006 may be provided in an integrated structure (for example, a touch panel).

Furthermore, these pieces of apparatus, including the processor 1001, the memory 1002 and so on are connected by the bus 1007 so as to communicate information. The bus 1007 may be formed with a single bus, or may be formed with buses that vary between pieces of apparatus.

Also, the radio base station 10 and the user terminal 20 may be structured to include hardware such as a microprocessor, a digital signal processor (DSP), an ASIC (Application-Specific Integrated Circuit), a PLD (Programmable Logic Device), an FPGA (Field Programmable Gate Array) and so on, and part or all of the functional blocks may be implemented by the hardware. For example, the processor 1001 may be implemented with at least one of these pieces of hardware.

(Variations)

Note that the terminology used in this specification and the terminology that is needed to understand this specification may be replaced by other terms that convey the same or similar meanings. For example, “channels” and/or “symbols” may be replaced by “signals (or “signaling”).” Also, “signals” may be “messages.” A reference signal may be abbreviated as an “RS,” and may be referred to as a “pilot,” a “pilot signal” and so on, depending on which standard applies. Furthermore, a “component carrier” (CC) may be referred to as a “cell,” a “frequency carrier,” a “carrier frequency” and so on.

Furthermore, a radio frame may be comprised of one or more periods (frames) in the time domain. Each of one or more periods (frames) constituting a radio frame may be referred to as a “subframe.” Furthermore, a subframe may be comprised of one or more slots in the time domain. A subframe may be a fixed time duration (for example, 1 ms) not dependent on the neurology.

Furthermore, a slot may be comprised of one or more symbols in the time domain (OFDM (Orthogonal Frequency Division Multiplexing) symbols. SC-FDMA (Single Carrier Frequency Division Multiple Access) symbols, and so on). Also, a slot may be a time unit based on neurology. Also, a slot may include a plurality of minislots. Each minislot may consist of one or more symbols in the time domain. Also, a minislot may be referred to as a “subslot.”

A radio frame, a subframe, a slot, a minislot and a symbol all represent the time unit in signal communication. A radio frame, a subframe, a slot, a minislot and a symbol may be each called by other applicable names. For example, one subframe may be referred to as a “transmission time interval” (TTI), or a plurality of consecutive subframes may be referred to as a “TTI,” or one slot or minislot may be referred to as a “TTI.” That is, a subframe and/or a TTI may be a subframe (1 ms) in existing LTE, may be a shorter period than 1 ms (for example, one to thirteen symbols), or may be a longer period of time than 1 ms. Note that the unit to represent the TTI may be referred to as a “slot,” a “minislot” and so on, instead of a “subframe.”

Here, a TTI refers to the minimum time unit of scheduling in radio communication, for example. For example, in LTE systems, a radio base station schedules the radio resources (such as the frequency bandwidth and transmission power that can be used in each user terminal) to allocate to each user terminal in TTI units. Note that the definition of TTIs is not limited to this.

The TTI may be the transmission time unit of channel-encoded data packets (transport blocks), code blocks and/or codewords, or may be the unit of processing in scheduling, link adaptation and so on. Note that when a TTI is given, the time interval (for example, the number of symbols) in which transport blocks, code blocks and/or codewords are actually mapped may be shorter than the TTI.

Note that, when one slot or one minislot is referred to as a “TTI,” one or more TTIs (that is, one or more slots or one or more minislots) may be the minimum time unit of scheduling. Also, the number of slots (the number of minislots) to constitute this minimum time unit of scheduling may be controlled.

A TTI having a time duration of 1 ms may be referred to as a “normal TTI” (TTI in LTE Rel. 8 to 12), a “long TTI,” a “normal subframe,” a “long subframe,” and so on. A TTI that is shorter than a normal TTI may be referred to as a “shortened TTI,” a “short TTI,” “a partial TTI (or a “fractional TTI”), a “shortened subframe,” a “short subframe,” a “minislot,” “a sub-slot” and so on.

Note that a long TTI (for example, a normal TTI, a subframe, etc.) may be replaced with a TTI having a time duration exceeding 1 ms, and a short TTI (for example, a shortened TTI) may be replaced with a TTI having a TTI length less than the TTI length of a long TTI and not less than 1 ms.

A resource block (RB) is the unit of resource allocation in the time domain and the frequency domain, and may include one or a plurality of consecutive subcarriers in the frequency domain. Also, an RB may include one or more symbols in the time domain, and may be one slot, one minislot, one subframe or one TTI in length. One TTI and one subframe each may be comprised of one or more resource blocks. Note that one or more RBs may be referred to as a “physical resource block (PRB: Physical RB),” a “subcarrier group (SCG),” a “resource element group (REG),” an “PRB pair,” an “RB pair” and so on.

Furthermore, a resource block may be comprised of one or more resource elements (REs). For example, one RE may be a radio resource region of one subcarrier and one symbol.

Note that the structures of radio frames, subframes, slots, minislots, symbols and so on described above are merely examples. For example, configurations pertaining to the number of subframes included in a radio frame, the number of slots included in a subframe, the number of minislots included in a slot, the number of symbols and RBs included in a slot or a minislot, the number of subcarriers included in an RB, the number of symbols in a TTI, the symbol duration, the length of cyclic prefixes (CPs) and so on can be variously changed.

Also, the information and parameters described in this specification may be represented in absolute values or in relative values with respect to given values, or may be represented in other information formats. For example, radio resources may be specified by given indices. In addition, equations to use these parameters and so on may be used, apart from those explicitly disclosed in this specification.

The names used for parameters and so on in this specification are in no respect limiting. For example, since various channels (PUCCH (Physical Uplink Control Channel). PDCCH (Physical Downlink Control Channel) and so on) and information elements can be identified by any suitable names, the various names assigned to these individual channels and information elements are in no respect limiting.

The information, signals and/or others described in this specification may be represented by using a variety of different technologies. For example, data, instructions, commands, information, signals, bits, symbols and chips, all of which may be referenced throughout the herein-contained description, may be represented by voltages, currents, electromagnetic waves, magnetic fields or particles, optical fields or photons, or any combination of these.

Also, information, signals and so on can be output from higher layers to lower layers and/or from lower layers to higher layers. Information, signals and so on may be input and output via a plurality of network nodes.

The information, signals and so on that are input may be transmitted to other pieces of apparatus. The information, signals and so on to be input and/or output can be overwritten, updated or appended. The information, signals and so on that are output may be deleted. The information, signals and so on that are input may be transmitted to other pieces of apparatus.

Reporting of information is by no means limited to the examples/embodiments described in this specification, and other methods may be used as well. For example, reporting of information may be implemented by using physical layer signaling (for example, downlink control information (DCI), uplink control information (UCI), higher layer signaling (for example, RRC (Radio Resource Control) signaling, broadcast information (the master information block (MIB), system information blocks (SIBs) and so on), MAC (Medium Access Control) signaling and so on), and other signals and/or combinations of these.

Note that physical layer signaling may be referred to as “L1/L2 (Layer 1/Layer 2) control information” (L1/L2 control signals). “L1 control information” (L1 control signal) and so on. Also, RRC signaling may be referred to as “RRC messages.” and can be, for example, an RRC connection setup message, RRC connection reconfiguration message, and so on. Also, MAC signaling may be reported using, for example, MAC control elements (MAC CEs (Control Elements)).

Also, reporting of given information (for example, reporting of information to the effect that “X holds”) does not necessarily have to be sent explicitly, and can be sent implicitly (by, for example, not reporting this piece of information).

Decisions may be made in values represented by one bit (0 or 1), may be made in Boolean values that represent true or false, or may be made by comparing numerical values (for example, comparison against a given value).

Software, whether referred to as “software,” “firmware,” “middleware,” “microcode” or “hardware description language,” or called by other names, should be interpreted broadly, to mean instructions, instruction sets, code, code segments, program codes, programs, subprograms, software modules, applications, software applications, software packages, routines, subroutines, objects, executable files, execution threads, procedures, functions and so on.

Also, software, commands, information and so on may be transmitted and received via communication media. For example, when software is transmitted from a website, a server or other remote sources by using wired technologies (coaxial cables, optical fiber cables, twisted-pair cables, digital subscriber lines (DSL) and so on) and/or wireless technologies (infrared radiation, microwaves and so on), these wired technologies and/or wireless technologies are also included in the definition of communication media.

The terms “system” and “network” as used herein are used interchangeably.

As used herein, the terms “base station (BS).” “radio base station,” “eNB.” “cell.” “sector,” “cell group,” “carrier,” and “component carrier” may be used interchangeably. A base station may be referred to as a “fixed station.” “NodeB,” “eNodeB (eNB),” “access point,” “transmission point,” “receiving point,” “femto cell,” “small cell” and so on.

A base station can accommodate one or more (for example, three) cells (also referred to as “sectors”). When a base station accommodates a plurality of cells, the entire coverage area of the base station can be partitioned into multiple smaller areas, and each smaller area can provide communication services through base station subsystems (for example, indoor small base stations (RRHs: Remote Radio Heads)). The term “cell” or “sector” refers to part or all of the coverage area of a base station and/or a base station subsystem that provides communication services within this coverage.

As used herein, the terms “mobile station (MS)” “user terminal,” “user equipment (UE)” and “terminal” may be used interchangeably. A base station may be referred to as a “fixed station,” “NodeB,” “eNodeB (eNB),” “access point,” “transmission point,” “receiving point,” “femto cell,” “small cell” and so on.

A mobile station may be referred to, by a person skilled in the art, as a “subscriber station,” “mobile unit,” “subscriber unit.” “wireless unit,” “remote unit,” “mobile device,” “wireless device,” “wireless communication device,” “remote device,” “mobile subscriber station,” “access terminal,” “mobile terminal,” “wireless terminal,” “remote terminal.” “handset,” “user agent,” “mobile client.” “client” or some other suitable terms.

Furthermore, the radio base stations in this specification may be interpreted as user terminals. For example, each aspect/embodiment of the present invention may be applied to a configuration in which communication between a radio base station and a user terminal is replaced with communication among a plurality of user terminals (D2D: Device-to-Device). In this case, user terminals 20 may have the functions of the radio base stations 10 described above. In addition, terms such as “uplink” and “downlink” may be interpreted as “side.” For example, an uplink channel may be interpreted as a side channel.

Likewise, the user terminals in this specification may be interpreted as radio base stations. In this case, the radio base stations 10 may have the functions of the user terminals 20 described above.

Certain actions which have been described in this specification to be performed by base station may, in some cases, be performed by upper nodes. In a network comprised of one or more network nodes with base stations, it is clear that various operations that are performed to communicate with terminals can be performed by base stations, one or more network nodes (for example, MMEs (Mobility Management Entities), S-GW (Serving-Gateways), and so on may be possible, but these are not limiting) other than base stations, or combinations of these.

The examples/embodiments illustrated in this specification may be used individually or in combinations, which may be switched depending on the mode of implementation. The order of processes, sequences, flowcharts and so on that have been used to describe the examples/embodiments herein may be re-ordered as long as inconsistencies do not arise. For example, although various methods have been illustrated in this specification with various components of steps in exemplary orders, the specific orders that are illustrated herein are by no means limiting.

Note that the radio communication system 1 may be applied to systems that use LTE (Long Term Evolution). LTE-A (LTE-Advanced), LTE-B (LTE-Beyond). SUPER 3G. IMT-Advanced, 4G (4th generation mobile communication system). 5G (5th generation mobile communication system), FRA (Future Radio Access). New-RAT (Radio Access Technology), NR (New Radio), NX (New radio access), FX (Future generation radio access), GSM (Global System for Mobile communications) (registered trademark), CDMA 2000, UMB (Ultra Mobile Broadband), IEEE 802.11 (Wi-Fi (registered trademark)), IEEE 802.16 (WiMAX(registered trademark)). IEEE 802.20, WB (Ultra-WideBand), Bluetooth (registered trademark) and other appropriate radio communication technologies, and/or may be applied to next-generation systems that are enhanced base on these radio communication technologies.

The phrase “based on” as used in this specification does not mean “based only on,” unless otherwise specified. In other words, the phrase “based on” means both “based only on” and “based at least on.”

Reference to elements with designations such as “first,” “second” and so on as used herein does not generally limit the number/quantity or order of these elements. These designations are used only for convenience, as a method for distinguishing between two or more elements. In this way, reference to the first and second elements does not imply that only two elements may be employed, or that the first element must precede the second element in some way.

The terms “judge” and “determine” as used herein may encompass a wide variety of actions. For example, to “judge” and “determine” as used herein may be interpreted to mean making judgements and determinations related to calculating, computing, processing, deriving, investigating, looking up (for example, searching a table, a database or some other data structure), ascertaining and so on. Furthermore, to “judge” and “determine” as used herein may be interpreted to mean making judgements and determinations related to receiving (for example, receiving information), transmitting (for example, transmitting information), inputting, outputting, accessing (for example, accessing data in a memory) and so on. In addition, to “judge” and “determine” as used herein may be interpreted to mean making judgements and determinations related to resolving, selecting, choosing, establishing, comparing and so on. In other words, to “judge” and “determine” as used herein may be interpreted to mean making judgements and determinations related to some action.

As used herein, the terms “connected” and “coupled,” or any variation of these terms, mean all direct or indirect connections or coupling between two or more elements, and may include the presence of one or more intermediate elements between two elements that are “connected” or “coupled” to each other. The coupling or connection between the elements may be physical, logical or a combination thereof. For example, “connection” may be interpreted as “access.” As used herein, two elements may be considered “connected” or “coupled” to each other by using one or more electrical wires, cables and/or printed electrical connections, and, as a number of non-limiting and non-inclusive examples, by using electromagnetic energy, such as electromagnetic energy having wavelengths in the radio frequency, microwave and optical regions (both visible and invisible).

When terms such as “include,” “comprise” and variations of these are used in this specification or in claims, these terms are intended to be inclusive, in a manner similar to the way the term “provide” is used. Furthermore, the term “or” as used in this specification or in claims is intended to be not an exclusive disjunction.

Now, although the present invention has been described in detail above, it should be obvious to a person skilled in the art that the present invention is by no means limited to the embodiments described herein. The present invention can be implemented with various corrections and in various modifications, without departing from the spirit and scope of the present invention defined by the recitations of claims. Consequently, the description herein is provided only for the purpose of explaining examples, and should by no means be construed to limit the present invention in any way.

The disclosure of Japanese Patent Application No. 2016-254324, filed on Dec. 27, 2016, including the specification, drawings and abstract, is incorporated herein by reference in its entirety.

1. A user terminal comprising:
a transmission section that transmits a random access preamble (PRACH);
a control section that controls the transmission of the PRACH by applying a specific PRACH configuration; and
a receiving section that receives a DL reference signal,
wherein the control section selects the specific PRACH configuration from a plurality of PRACH configurations, which are associated respectively with a plurality of reference signal configurations that are applied to the transmission of the DL reference signal.

2. The user terminal according to claim 1, wherein the receiving section receives information related to plurality of PRACH configurations and information related to reference signal configurations associated with each PRACH configuration.

3. The user terminal according to claim 1, wherein the receiving section receives the DL reference signal based on a first reference signal configuration that corresponds to the specific PRACH configuration.

4. The user terminal according to claim 1, wherein, when the transmission section transmits a UL reference signal, the control section controls the transmission of the UL reference signal by applying a reference signal configuration that is associated with the specific PRACH configuration, or by applying a reference signal configuration that is reported separately.

5. The user terminal according to claim 1, wherein, when, the PRACH is transmitted, information related to a second reference signal configuration is received, the receiving section receives the DL reference signal based on the second reference signal configuration.

6. A radio communication method for a user terminal, comprising the steps of:
transmitting a random access preamble (PRACH);
controlling the transmission of the PRACH by applying a specific PRACH configuration; and
receiving a DL reference signal,
wherein the user terminal selects the specific PRACH configuration from a plurality of PRACH configurations, which are associated respectively with a plurality of reference signal configurations that are applied to the transmission of the reference signal.

7. The user terminal according to claim 2, wherein the receiving section receives the DL reference signal based on a first reference signal configuration that corresponds to the specific PRACH configuration.

8. The user terminal according to claim 2, wherein, when the transmission section transmits a UL reference signal, the control section controls the transmission of the UL reference signal by applying a reference signal configuration that is associated with the specific PRACH configuration, or by applying a reference signal configuration that is reported separately.

9. The user terminal according to claim 3, wherein, when the transmission section transmits a UL reference signal, the control section controls the transmission of the UL reference signal by applying a reference signal configuration that is associated with the specific PRACH configuration, or by applying a reference signal configuration that is reported separately.

10. The user terminal according to claim 2, wherein, when, the PRACH is transmitted, information related to a second reference signal configuration is received, the receiving section receives the DL reference signal based on the second reference signal configuration.

11. The user terminal according to claim 3, wherein, when, the PRACH is transmitted, information related to a second reference signal configuration is received, the receiving section receives the DL reference signal based on the second reference signal configuration.

12. The user terminal according to claim 4, wherein, when, the PRACH is transmitted, information related to a second reference signal configuration is received, the receiving section receives the DL reference signal based on the second reference signal configuration.
